(19) United States
(12) Patent Application Publication
(10) Pub. No.: US 2022/0061530 A1
(43) Pub. Date: Mar. 3, 2022

(54) CORNER FITTING

(71) Applicant: Häfele Berlin GmbH & Co KG, Berlin (DE)

(72) Inventor: Ulrich Merz, Regensburg (DE)

(73) Assignee: Häfele Berlin GmbH & Co KG, Berlin (DE)

(21) Appl. No.: 17/454,244

(22) Filed: Nov. 9, 2021

Related U.S. Application Data
(63) Continuation of application No. PCT/EP2020/054740, filed on Feb. 24, 2020.

(30) Foreign Application Priority Data
May 20, 2019 (DE) 20 2019 102 829.7

(51) Int. Cl. A47B 88/90; F16B 5/00; F16B 12/10

(52) U.S. Cl. CPC A47B 88/941; F16B 12/10; F16B 5/0084

(57) ABSTRACT

A corner fitting includes a strip-like base member for a clamping connection between two furniture panels which are arranged substantially perpendicularly to each other. A lip protrudes from the corner fitting in an end region of the base member along at least a portion of the width. In the opposing end region of the base member a pin protrudes, wherein the lip and the pin protrude at the same side of the base member substantially in the same direction.

### CROSS-REFERENCE TO RELATED APPLICATIONS

This continuation application claims priority to PCT/EP2020/054740 filed on Feb. 24, 2020 which has published as WO 2020/233845 A1 and the German Utility Model Application No. 20 2019 102 829.7, filed May 20, 2019, the entire contents of which are hereby incorporated in full by these references.

### DESCRIPTION

### Field of the Invention

The invention relates to a corner fitting for a clamping connection between two furniture panels which are arranged substantially perpendicularly to each other. Such corner fittings serve, for example, to stabilize corners of furniture panels as produced, for example, when side walls and rear walls of items of furniture or furniture components meet each other, such as, for example, drawers.

### Background of the Invention

A corner fitting profile which is configured for a snap-fit connection in order to stabilize a corner of a furniture module outside is known from DE 20 2018 107 189 Ul. The corner fitting profile comprises two plates which are arranged in a substantially L-shaped manner. Each plate has a lip which protrudes from the plate. The lips are provided to engage in each case in a groove of a furniture panel.

### SUMMARY OF THE INVENTION

An object of the present invention is to improve a fitting of the type mentioned in the introduction in particular with regard to simpler handling capacity and simpler and more rapid assembly capacity.

This object is achieved by a fitting having the features of claim 1. The dependent claims relate to advantageous developments of the fitting according to the invention.

According to the invention, the corner fitting comprises a strip-like base member, in one end region of which there is arranged a lip which protrudes from the base member along at least a portion of the width of the base member. In the end region of the base member opposite the lip, there is arranged a pin which also protrudes from the base member. The pin and the lip protrude at the same side of the base member and substantially in the same direction. As a result of such a construction of the corner fitting, a manageable configuration of the corner fitting with at the same time easy assembly capacity and a stable connection is possible. The lip may, for example, engage around a furniture panel at the rear side and the pin for clamping may be inserted into a recess, for example, hole, of the second furniture panel. This insertion can be carried out, for example, in a tool-free manner by pressing with a finger.

In an advantageous embodiment, the corner fitting is constructed integrally, preferably from resilient material. As a result of the integral configuration, particularly in conjunction with the resilient material, a resilient property can be achieved, whereby the corner fitting in the installed state can be placed under tension and a fixed connection action can consequently be achieved.

In an embodiment of the invention, the side of the lip facing the pin forms an acute angle with the base member, that is to say, an angle less than 90°. This acute angle between the lip and the base member may be expanded in the installed state, that is to say, it may become larger, become approximately 90° or under some circumstances become greater than 90°. It is thereby possible to achieve clamping of the corner fitting in the installed state and consequently a secure connection action.

In a preferred embodiment of the invention, the base member of the corner fitting comprises a linear portion from which the lip protrudes. The side of the linear portion opposite the lip is adjoined by a bent portion of the base member. The pin protrudes from the bent portion of the base member, preferably in a direction perpendicular to the linear portion. Preferably, the bent portion is bent toward the side of the base member from which the lip and the pin protrude. The bent portion gives the strip-like base member an ergonomic shaping, which promotes the pressing-in action of the pin, for example, with a thumb, into a recess of a furniture component. At the same time, the bent shape has a resilient property, with which the corner fitting can be placed under tension in the installed state and whereby a secure connection action can be achieved.

The pin is, for example, configured as a hollow pin and/or has an open ring as cross sections. These features individually or in combination provide the pin with a degree of resilience and enable a compression so that the introduction into a recess, for example, hole, is facilitated. A clamping of the corner fitting in the assembled state is thereby also facilitated.

The opening of the pin may be located, for example, at the side of the pin facing away from the lip. This is advantageous since the side of the pin facing the lip can thus be available in order to promote clamping of the corner fitting in the assembled state.

For better assembly capacity and in order to improve the anchoring of the pin in a recess, the pin may have on the outer side thereof axially extending indentations or webs. The capacity for handling and assembly can thereby be further improved.

In particular by fitting tooth-like indentations which extend in the circumferential direction of the pin to a web at the side of the pin facing the lip, an anchoring of the pin in the recess can be achieved. To this end, a shape of the indentations which provide planes which are oblique in the introduction direction and which support the introduction and act in the opposite direction as barbs is advantageous.

Preferably, the pin tapers conically in its extent away from the base member, that is to say, the outer diameter thereof becomes smaller distance from the base member. For example, the pin has in the region with which it adjoins the base member an outer diameter of more than 5 mm. This outer diameter then becomes smaller in the extent of the conical tapering. This embodiment enables easier insertion of the pin into a recess of a furniture component and thus simplifies the capacity for handling and the assembly.

The invention also relates in another aspect to a furniture module for forming a portion of an item of furniture with a corner fitting according to the invention. In this instance, the furniture module comprises two furniture panels which are arranged substantially perpendicularly to each other, wherein a first furniture panel is arranged in a groove of a second furniture panel. The pin of the corner fitting is inserted into a recess of the first furniture panel and the lip engages behind the second furniture panel at the outer side. The recess of the first furniture panel is in this instance preferably a hole with a diameter which is adapted to the pin, for example, with a diameter between 1 and 10 mm, preferably between 4 mm and 6 mm, very preferably approximately 5 mm. The hole is preferably arranged between 10 mm and 30 mm, very preferably approximately 24 mm, from the outer side of the second furniture panel.

Preferably, the first furniture panel is a rear wall of a drawer and the second furniture panel is a side wall of a drawer. With higher drawers, for example, from a height of 100 mm, a plurality of corner fittings according to the invention may also be inserted one above the other in order to improve the stability.

Other advantages of the invention will be appreciated from the description, the claims and the drawings. The features which are mentioned above and those set out below may also be used individually per se or together in any combinations. The embodiments shown and described are not intended to be understood to be a definitive listing, but are instead of an exemplary nature in order to describe the invention.

### BRIEF DESCRIPTION OF THE DRAWINGS

In the drawings:

FIG. 1 is a side view of the corner fitting according to the invention;

FIG. 2 is a sectioned view through the corner fitting along the line A-A;

FIG. 3 is a perspective view of the corner fitting;

FIG. 4 is a schematic view of a furniture module; and

FIG. 5 is a schematic illustration of a furniture module with a corner fitting.

### DETAILED DESCRIPTION OF THE PREFERRED EMBODIMENTS

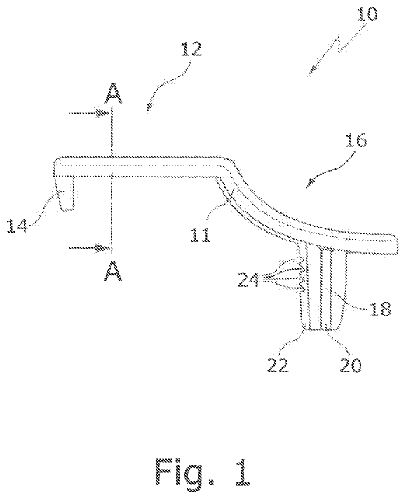

FIG. 1 is a side view of a corner fitting 10 having a strip-like base member 11. The base member 11 has a linear portion 12, at the end of which a lip 14 protrudes. The side of the linear portion 12 opposite the lip 14 is adjoined by a bent portion 16 of the base member 11. A pin 18 protrudes from the bent portion 16 of the base member 11. The pin has webs 20, 22 which extend in an axial direction. The web 22 facing the lip 14 has indentations 24 which extend in the circumferential direction of the pin and which are tooth-like and which, as a result of their shape, can act as barbs.

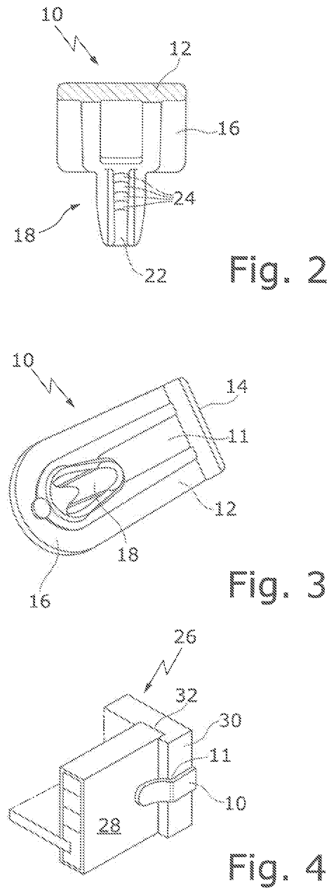

FIG. 2 is a sectioned view through the corner fitting 10 along the line A-A from FIG. 1. The linear portion 12 is adjoined by the bent portion 16 from which the pin 18 whose web 22 has indentations 24 which extend in a circumferential direction protrudes.

The perspective illustration of the corner fitting 10 of FIG. 3 shows the open shape of the pin 18 which protrudes from the bent portion 16 of the base member 11. The lip 14 protrudes from the linear portion 12 of the base member 11. The opening of the pin 18 is located at the side of the pin 18 facing away from the lip 14.

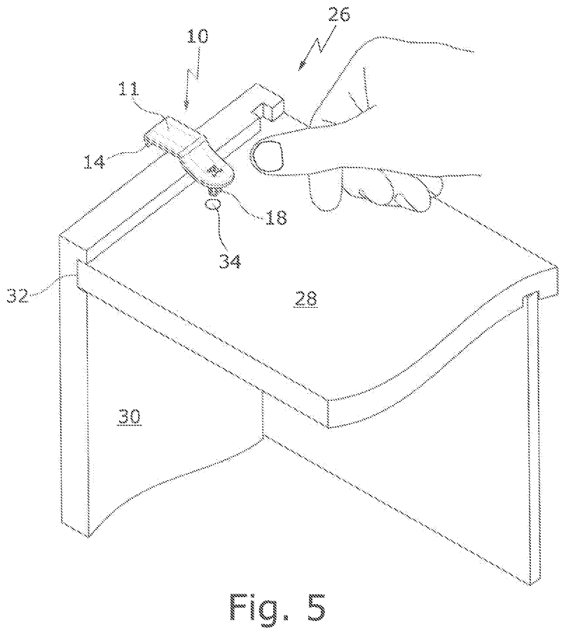

FIG. 4 shows a furniture module 26 for forming a portion of an item of furniture. A first corner plate 28, for example, a rear wall of a drawer, is arranged perpendicularly to a second furniture wall 30, for example, a side wall of a drawer. In this instance, the first furniture panel is arranged in a groove 32 of the second furniture panel. The corner fitting 10 with the strip-like base member thereof acts in this example as a rear wall connector, for example, of a drawer, in which the lip 14 (FIG. 5) of the corner fitting 10 engages around the outer rear edge of the second furniture panel and the pin 18 (FIG. 5) of the corner fitting 10 is introduced into a hole 34 (FIG. 5) of the first side wall. In the schematic illustration of FIG. 4, a rear corner of such a drawer is illustrated, the corner connector 10 can preferably be used in the same manner as a rear wall connector for the other rear corner of the drawer. To this end, the rear wall of the drawer is preferably embedded in grooves of both side walls, also referred as side frames.

FIG. 5 schematically illustrates how the corner fitting can be connected to the furniture panels for assembly. To this end, the lip 14 of the corner fitting 10 may preferably be suspended on the edge of the side wall 30 and subsequently fixed by pressing with a finger on the bent portion 16 in a hole 34 of the rear wall 28. The preferred shaping of the corner fitting brings about in this instance a resilient clamping and enables a secure and—if desired—permanent connection which may, however, be released, if necessary.

### LIST OF REFERENCE NUMERALS

10 Corner fitting
11 Base member
12 Linear portion
14 Lip
16 Bent portion
18 Pin
20 Web
22 Web
24 Indentations
26 Furniture module
28 First furniture panel
30 Second furniture panel
32 Groove
34 Hole

What is claimed is:

1. A corner fitting, comprising:
a strip-like base member for a clamping connection between two furniture panels which are arranged substantially perpendicularly to each other;
wherein a lip protrudes from the corner fitting in an end region of the base member along at least a portion of a width and a pin protrudes in an opposing end region of the base member;
wherein the lip and the pin protrude at the same side of the base member substantially in the same direction.

2. The corner fitting as claimed in claim 1, wherein the corner fitting is constructed integrally from a resilient material being a metal or plastics material.

3. The corner fitting as claimed in claim 1, wherein the side of the lip facing the pin forms an acute angle with the base member.

4. The corner fitting as claimed in claim 1, wherein the base member comprises a linear portion and a bent portion, wherein the lip protrudes from the linear portion and the pin protrudes from the bent portion and the bent portion adjoins the linear portion at the side opposite the lip.

5. The corner fitting as claimed in claim 4, wherein the bent portion is bent in the direction in which the lip and the pin protrude.

6. The corner fitting as claimed in claim 4, wherein the pin protrudes from the bent portion in a direction which extends perpendicularly to the linear portion.

7. The corner fitting as claimed in claim 1, wherein the pin is configured as a hollow pin.

8. The corner fitting as claimed in claim 7, wherein the pin has an open ring as a cross section.

9. The corner fitting as claimed in claim 1, wherein the pin tapers conically in its extent away from the base member.

10. The corner fitting as claimed in claim 1, wherein the pin has at the outer side thereof axially extending indentations or webs.

11. The corner fitting as claimed in claim 10, wherein a web which faces the lip has tooth-like indentations which extend in the circumferential direction of the pin.

12. A furniture module for forming a portion of an item of furniture comprising the corner fitting as claimed in claim 1 and a first furniture panel and a second furniture panel, wherein the furniture panels are arranged substantially perpendicularly to each other and the first furniture panel is inserted into a groove of the second furniture panel, the pin of the corner fitting is inserted into a recess of the first furniture panel and the lip engages behind the second furniture panel at the outer side.

13. The furniture module as claimed in claim 12, wherein the first furniture panel is a rear wall of a drawer and the second furniture panel is a side wall of the drawer.
